(19) United States
(12) Patent Application Publication
(10) Pub. No.: US 2009/0208012 A1
(43) Pub. Date: Aug. 20, 2009

(54) DECRYPTION SYSTEM AND RELATED METHOD THEREOF

(76) Inventor: Feng-Jian Chou, Miaoli County (TW)

Correspondence Address: NORTH AMERICA INTELLECTUAL PROPERTY CORPORATION, P.O. BOX 506, MERRIFIELD, VA, 22116, US

(21) Appl. No.: 12/349,519

(22) Filed: Jan. 7, 2009

(30) Foreign Application Priority Data
Feb. 15, 2008 (TW) 097105450

(51) Int. Cl. H04L 9/08

(52) U.S. Cl. 380/270; 380/283; 340/10.1

(57) ABSTRACT

A decryption system is provided. The decryption system includes a first RFID tag, a second code providing apparatus and a decryption module. The first RFID tag is for storing an encrypted data generated by encrypting an original data according to a first code. The second code providing apparatus is for providing a second code. The decryption module includes an RFID reader and a computing unit. The RFID reader reads the encrypted data from the first RFID tag. The computing unit receives the second code from the second code providing apparatus without utilizing the Internet, and decrypts the encrypted data according to the second code to obtain the original data.

### BACKGROUND OF THE INVENTION

1. Field of the Invention

The present invention relates to a decryption system and a method thereof, and particularly relates to a decryption system utilizing an RFID system and a method thereof.

2. Description of the Prior Art

In the field of cryptology, a private key Pri is utilized for encrypting an original data M to generate an encrypted data Pri(M). After that, a corresponding public key Pub is used to decrypt the encrypted data Pri(M) to obtain the original data M. When applied to the manufacture of products, the original data M can be the product identification information, the private key Pri is provided by the manufacturer, and the encrypted data Pri(M) is attached to the product during the manufacturing process. Also, the user can obtain an opened public key Pub to obtain the original data M.

FIG. 1 is a schematic diagram illustrating a prior art system that can obtain a private key and a public key to acquire product identification information. As shown in FIG. 1, the apparatus 101 (i.e., the above-mentioned product) is a camera, which is stored with an encrypted data Pri(M). A user can utilize a portable electronic apparatus 103 such as a mobile phone to receive the encrypted data Pri(M) from the apparatus 101, and receive a public key Pub from a server 107 via the Internet. Then the user can utilize the public key Pub to decrypt the encrypted data Pri(M) to obtain original data M. As in the above-mentioned description, if the original data M is identification information, the apparatus 101 can be identified successfully when the data encrypted by the public key Pub is correct.

However, since the cost for connecting to the Internet via a mobile phone is very expensive, and a complicated application must be used and confirmation steps also need be performed if the mobile phone user wishes to have the Internet function, user inconvenience and burden are caused.

### SUMMARY OF THE INVENTION

Therefore, one objective of the present invention is to provide a decryption system utilizing an RFID system, to obtain a desired code and to decrypt accordingly to obtain the original data.

One embodiment of the present invention discloses a decryption system. The decryption system comprises a first RFID tag, a second code providing apparatus and a decryption module. The first RFID tag serves to store an encrypted data generated by encrypting an original data according to a first code. The second code providing apparatus serves to provide a second code. The decryption module comprises an RFID reader and a computing unit. The RFID reader reads the encrypted data from the first RFID tag. The computing unit receives the second code from the second code providing apparatus without utilizing the Internet, and decrypts the encrypted data according to the second code to obtain the original data.

Another embodiment of the present invention discloses a decryption method. The method comprises steps of: (a) utilizing a first RFID tag for storing an encrypted data, which is generated by encrypting an original data according to a first code; (b) utilizing an RFID reader to read the encrypted data from the first RFID tag; and (c) receiving a second code from a second code providing apparatus without utilizing the Internet, and decrypting the encrypted data according to the second code to obtain the original data.

According to above-mentioned embodiment, the disadvantage of utilizing a mobile phone to directly receive a code via the Internet of the prior art can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a prior art system that can obtain a private key and a public key to acquire product identification information.

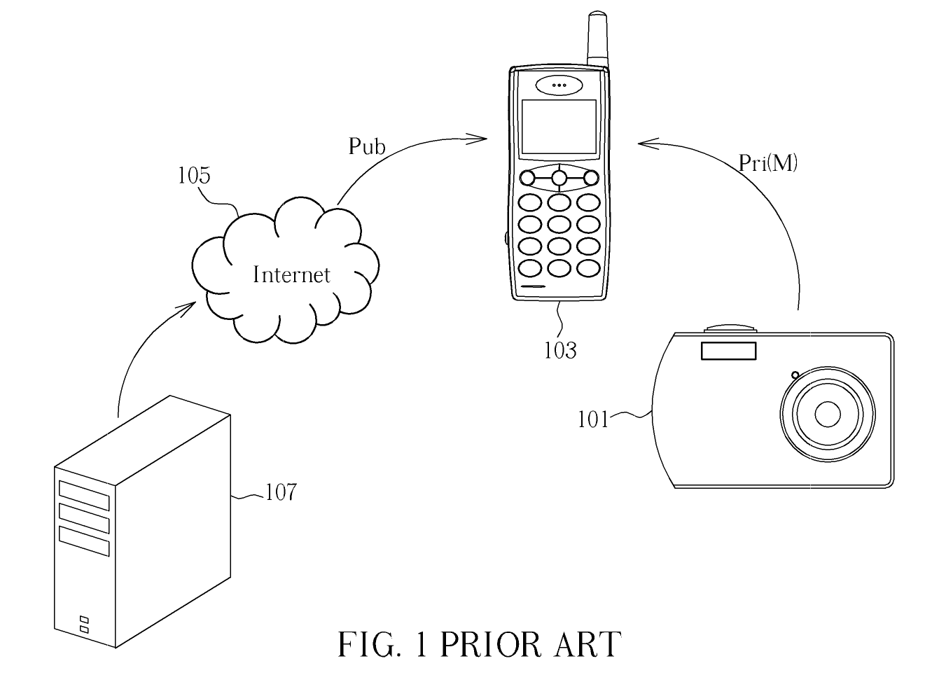

FIG. 2 is a schematic diagram illustrating a decryption system, which utilizes an RFID system, according to an embodiment of the present invention.

FIG. 3 is a schematic diagram illustrating a system, which utilizes the decryption system shown in FIG. 2, for obtaining a private key and a public key to acquire product identification information.

### DETAILED DESCRIPTION

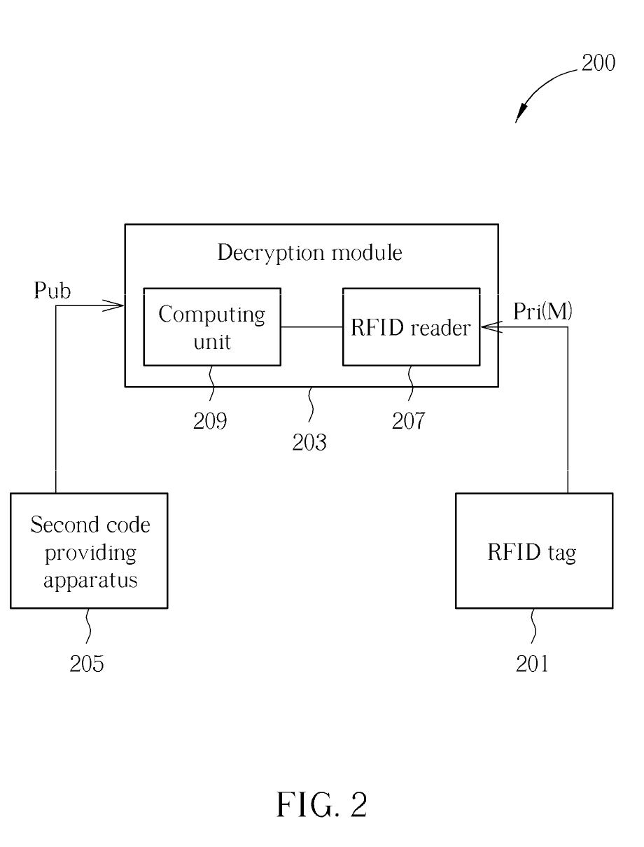

FIG. 2 is a schematic diagram illustrating a decryption system 200, which utilizes an RFID system, according to an embodiment of the present invention. As shown in FIG. 2, the decryption system 200 comprises an RFID tag 201, a decryption module 203, and a second code providing apparatus 205. The decryption module 203 comprises an RFID reader 207 and a computing unit 209. The RFID tag 201 is used for storing an encrypted data generated via encrypting an original data M according to a first code. The second code providing apparatus 205 is utilized for providing a second code. The RFID reader 207 is used for reading the encrypted data from the RFID tag 201. The computing unit 209 is used for receiving a second code from the second code providing apparatus 205 without utilizing the Internet, and for decrypting the encrypted data according to the second code to obtain the original data M.

In this embodiment, the first code is a private key Pri, and the second code is a public key Pub. Accordingly, the RFID reader 207 reads the encrypted data Pri(M), which is encrypted by the private key Pri, from the RFID tag 201, and the second code providing apparatus 205 provides the public key Pub to the decryption module 203. It should be noted that the first code and the second code are not limited to the private key Pri and the public key Pub, but all codes in pair can be utilized in the present application. That is, if a code can be utilized for encrypting an original data to generate an encrypted data, and the other one of the code in pair can be utilized for decrypting the encrypted data to obtain the original data; such codes in pair can be applied to the present invention.

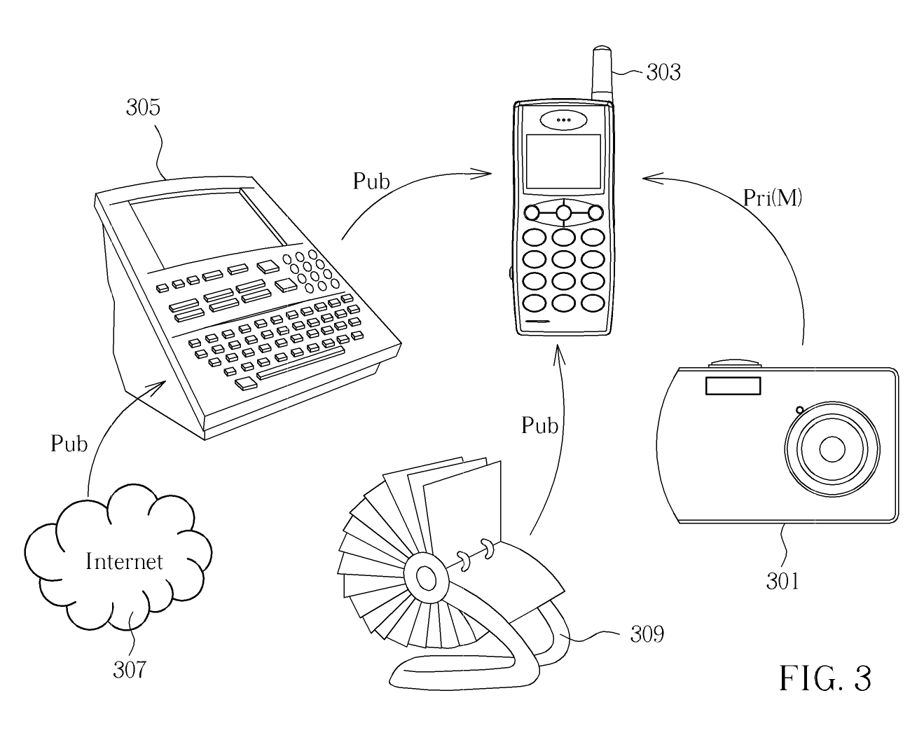

FIG. 3 is a schematic diagram illustrating a system, which utilizes the decryption system shown in FIG. 2, for obtaining a private key and a public key to acquire product identification information. In this embodiment, the above-mentioned RFID tag 201 is located in an apparatus 301, which is a product to be identified, e.g., a camera in this embodiment. The decryption module 203 is provided in a portable electronic apparatus 303, which is a mobile phone in this embodiment. Further, the decryption module 203 and the portable electronic apparatus 303 can jointly utilize the computing unit 209, such that no extra cost is needed.

The second code providing apparatus 205 can be a key searching apparatus 305, which can obtain a public key Pub via a server. Also, the decryption module 203 of the portable electronic apparatus 303 can utilize a wireless communication such as Bluetooth or infrared to receive the public key Pub from the key searching apparatus 305. In addition, if the key searching apparatus 305 comprises an RFID tag for storing the public key Pub from the Internet 307, the decryption module 203 can utilize the RFID reader 207 to receive the public key Pub from the key searching apparatus 305. Then, the public key Pub is utilized for decrypting the above-mentioned encrypted data Pri(M) to obtain the original data M.

The second code providing apparatus 205 may be a tag collecting apparatus 309 comprising a plurality of RFID tags (not illustrated), which are respectively utilized for storing a plurality of candidate public keys. The decryption module 203 utilizes the RFID reader 207 to select one of the candidate public keys as the public key Pub. As known by persons skilled in the art, since there must be a negotiation algorithm between an RFID reader and an RFID tag, the RFID reader 207 can read a corresponding RFID tag from the RFID tags comprised in the tag collecting apparatus 309 according to the RFID tag in the apparatus 301, to obtain the correct public key Pub. After that, the public key Pub is utilized for decrypting the above-mentioned encrypted data Pri(M) to obtain the original data M.

The above-mentioned key searching apparatus 305 and tag collecting apparatus 309 can be provided to a market where the product 30 is sold, whereby the identification of the product may be easily completed while the user purchases the product.

A corresponding decryption method can be obtained via the above-mentioned concept, thus description of the method is omitted for brevity.

According to the above-mentioned embodiment, the disadvantage of the prior art can be avoided. That is, the disadvantage of utilizing a mobile phone to receive a code via the Internet. In addition, the convenience for a user identifying the product is increased.

Those skilled in the art will readily observe that numerous modifications and alterations of the device and method may be made while retaining the teachings of the invention.

What is claimed is:

1. A decryption system, comprising:
a first RFID tag, for storing an encrypted data generated by encrypting an original data according to a first code;
a second code providing apparatus, for providing a second code; and
a decryption module, comprising:
an RFID reader, for reading the encrypted data from the first RFID tag; and
a computing unit, coupled to the RFID reader, for receiving the second code from the second code providing apparatus, without accessing the Internet, and for decrypting the encrypted data according to the second code to obtain the original data.

2. The decryption system of claim 1, wherein the first code is a private key, and the second code is a public key.

3. The decryption system of claim 1, wherein the first RFID tag is provided in an apparatus, and the original data comprises identification information of the apparatus.

4. The decryption system of claim 1, wherein the decryption module is in a portable electronic apparatus.

5. The decryption system of claim 4, wherein the portable electronic apparatus is a mobile phone, and the decryption module and the mobile phone jointly utilize the computing unit.

6. The decryption system of claim 1, wherein the second code providing apparatus obtains the second code through the Internet.

7. The decryption system of claim 6, wherein the decryption module further comprises a wireless communication system for receiving the second code from the second code providing apparatus.

8. The decryption system of claim 6, wherein the decryption module utilizes the RFID reader to receive the second code from the second code providing apparatus.

9. The decryption system of claim 1, wherein the second code providing apparatus comprises a plurality of second RFID tags for respectively storing a plurality of candidate second codes, and the decryption module utilizes the RFID reader to choose one of the candidate second codes as the second code.

10. A decryption method, comprising:
(a) utilizing a first RFID tag for storing an encrypted data generated by encrypting an original data according to a first code;
(b) utilizing an RFID reader to read the encrypted data from the first RFID tag; and
(c) receiving a second code from a second code providing apparatus, without accessing the Internet, and decrypting the encrypted data according to the second code to obtain the original data.

11. The decryption method of claim 10, wherein the first code is a private key, and the second code is a public key.

12. The decryption method of claim 10, wherein the first RFID tag is provided in an apparatus, and the original data comprises identification information of the apparatus.

13. The decryption method of claim 10, wherein the second code providing apparatus obtains the second code through the Internet.

14. The decryption method of claim 13, wherein the step (c) further comprises utilizing a wireless communication system to receive the second code from the second code providing apparatus.

15. The decryption method of claim 13, wherein the step (c) further comprises utilizing the RFID reader to receive the second code from the second code providing apparatus.

16. The decryption method of claim 10, wherein the second code providing apparatus comprises a plurality of second RFID tags for respectively storing a plurality of candidate second codes, and the step (b) utilizes the RFID reader to choose one of the candidate second codes as the second code.
